(19) United States
(12) Patent Application Publication
(10) Pub. No.: US 2024/0413295 A1
(43) Pub. Date: Dec. 12, 2024

(54) METHODS FOR STIFFENING WIRE MESH CURRENT COLLECTORS FOR ELECTRODES OF BATTERY CELLS

(71) Applicant: GM GLOBAL TECHNOLOGY OPERATIONS LLC, Detroit, MI (US)

(72) Inventors: Andrew Clay BOBEL, Troy, MI (US); Diptak BHATTACHARYA, Royal Oak, MI (US); Zhenke TENG, Troy, MI (US); Caleb REESE, Ferndale, MI (US); Sayed Yousef Sayed NAGY, Troy, MI (US); Anil K. SACHDEV, Rochester Hills, MI (US)

(21) Appl. No.: 18/330,724

(22) Filed: Jun. 7, 2023

(51) Int. Cl. H01M 4/04; H01M 4/66; H01M 4/75

(52) U.S. Cl. CPC H01M 4/0435; H01M 4/0404; H01M 4/0471; H01M 4/661; H01M 4/75

(57) ABSTRACT

A method for manufacturing a current collector for an electrode of a battery cell includes providing a wire mesh current collector including wires that have a diameter and form mesh junctions; and rolling the wire mesh current collector using a first roller and a second roller, wherein the first roller and the second roller are spaced by a predetermined gap. The predetermined gap is less than 2 times the diameter of the wires of the wire mesh current collector.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to current collectors for electrodes of battery cells, and more particularly to a method for stiffening wire mesh current collectors of battery cells.

Electric vehicles (EVs) such as battery electric vehicles (BEVs), hybrid vehicles, and/or fuel cell vehicles include one or more electric machines and a battery system including one or more battery cells, modules and/or packs. A battery control module is used to control charging and/or discharging of the battery system during charging and/or driving. Manufacturers of EVs are pursuing increased power density to increase the range of the EVs.

### SUMMARY

A method for manufacturing a current collector for an electrode of a battery cell includes providing a wire mesh current collector including wires that have a diameter and form mesh junctions; and rolling the wire mesh current collector using a first roller and a second roller, wherein the first roller and the second roller are spaced by a predetermined gap. The predetermined gap is less than 2 times the diameter of the wires of the wire mesh current collector.

In other features, the predetermined gap is in a range from greater than or equal to 1 times the diameter of the wires of the wire mesh current collector. The diameter of the wires is in a range from 4 μm to 100 μm. The wires of the wire mesh current collector are made of one or more materials selected from a group consisting of copper, stainless steel, brass, bronze, zinc, and aluminum. The predetermined gap is in a range from greater than or equal to 1 and less than or equal to 1.5 times the diameter of the wires of the wire mesh current collector.

In other features, the method includes arranging an anode active material layer adjacent to the wire mesh current collector. The method includes arranging a cathode active material layer adjacent to the wire mesh current collector. The method includes coating the wire mesh current collector with a slurry including anode active material. The method includes coating the wire mesh current collector with a slurry including cathode active material.

A method for manufacturing a current collector for an electrode of a battery cell includes providing a wire mesh current collector including wires that have a diameter and form mesh junctions; rolling the wire mesh current collector using a first roller and a second roller, wherein the first roller and the second roller are spaced by a predetermined gap; and supplying current to the first roller and the second roller to heat the wire mesh current collector to at least one of fuse, bond and weld the wires at the mesh junctions. The predetermined gap is less than 2 times the diameter of the wires of the wire mesh current collector.

In other features, the predetermined gap is greater than or equal to the diameter of the wires of the wire mesh current collector. The diameter of the wires is in a range from 4 μm to 100 μm. The wires of the wire mesh current collector are made of one or more materials selected from a group consisting of copper, stainless steel, brass, bronze, and aluminum. The predetermined gap is in a range from greater than or equal to 1.5 and less than or equal to 2 times the diameter of the wires of the wire mesh current collector.

In other features, the method includes arranging an anode active material layer adjacent to the wire mesh current collector. The method includes arranging a cathode active material layer adjacent to the wire mesh current collector. The method includes coating the wire mesh current collector with a slurry including anode active material. The method includes coating the wire mesh current collector with a slurry including cathode active material.

In other features, the first roller and the second roller include a radially outer layer comprising a refractory metal. The refractory metal is selected from a group consisting of tungsten, molybdenum, and an alloy of copper and tungsten. The method includes coating the wire mesh current collector prior to rolling using one or more materials selected from a group consisting of tin (Sn), indium (In), bismuth (Bi), zinc (Zn), and combinations thereof.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of a battery cell including electrodes with strengthened and/or stiffened wire mesh current collectors according to the present disclosure;

FIGS. 2A and 2B are plan views illustrating tensile testing of a wire mesh current collector in two directions before strengthening and/or stiffening;

FIG. 3 is a graph illustrating load as a function of displacement in the two directions in FIGS. 2A and 2B;

FIG. 4 is a photo of a cutaway wire mesh current collector before strengthening and/or stiffening;

FIG. 5 illustrates an example of a method for strengthening and/or stiffening of a wire mesh current collector using skin pass rolling according to the present disclosure;

FIGS. 6A and 6B are graphs illustrating load as a function of displacement to show performance increases after strengthening and/or stiffening of the wire mesh current collector;

FIGS. 7A and 7B are photos of examples of wires at mesh junctions before and after strengthening and/or stiffening of the wire mesh current collector according to the present disclosure;

FIG. 8 illustrates an example of another method for strengthening and/or stiffening of the wire mesh current collector using roll resistance welding according to the present disclosure; and

FIGS. 9 to 10B are photos of wires at a mesh junction before and after strengthening and/or stiffening of the wire mesh current collector using the method in FIG. 8.

In the drawings, reference numbers may be reused to identify similar and/or identical elements.

### DETAILED DESCRIPTION

While the battery cells according to the present disclosure are described herein in the context of electric vehicles, the battery cells can be used in stationary applications and/or in other types of applications.

Battery cells include anode electrodes, cathode electrodes, and separators arranged in a predetermined order in an enclosure. The anode electrodes include an anode active layer arranged on one or both sides of an anode current collector. The cathode electrodes include a cathode active layer arranged on one or both sides of a cathode current collector.

The anode and cathode current collectors may include foil, wire mesh, or expanded metal. For example, wire mesh current collectors can be using wire made of copper, stainless steel, brass, bronze, aluminum, etc. (e.g., Cu-100 or SS-100). The wire mesh may be fabricated with wires that are 4 μm to 100 μm thick (e.g., 30 μm). In some examples, the wire mesh has about 100 to 300 openings per square inch (e.g., 100). In some examples, the wire mesh has low strength, stiffness, and/or resistance to deformation which makes it difficult to handle during electrode fabrication.

The present disclosure relates to methods for strengthening and/or stiffening the wire mesh current collectors used in anode electrodes and/or cathode electrodes. In some examples, the wire mesh current collectors can be arranged adjacent to an anode or cathode active layer (e.g., such as a lithium foil layer) to form an anode or cathode electrode. In other examples, slurry including the anode or cathode active material, binder, conductive additives, and/or solvent can be used to coat the wire mesh current collector in a roll-to-roll process to create an anode or cathode electrode.

For example, the wire mesh may be used as a three-dimensional current collectors (3DCC) in next generation lithium metal batteries. 3DCCs (such as Cu (or SS) interwoven wire meshes) have demonstrated benefits in manufacturing ultrawide Li anodes (on the order of 500+ mm) with improved cycling performance as compared to traditional foil-based anode current collectors.

In some examples, the wire mesh current collectors is made with 30 μm thick Cu (or SS) wires with about 70% open area. The wire mesh current collector is lighter than 6 μm foil current collectors (e.g., Cu or SS). However, the wire mesh current collector is flimsy and difficult to handle during rolling insertion of lithium. The low stiffness of the wire mesh current collector is due to little or no bonding between wires that overlap at mesh junctions.

In some examples, the wire mesh current collectors according to the present disclosure are strengthened and/or stiffened by rolling of the wire mesh current collector (e.g., skin pass rolling) to press the mesh junctions together so that the wires are locked in place at the mesh junctions. In other examples, the wire mesh current collectors according to the present disclosure are strengthened and/or stiffened by passing the wire mesh current collector between rollers. The rollers are connected to a power source that supplies current through the rollers and the wire mesh current collector to fuse, bond and/or weld the wires of the wire mesh at the mesh junctions.

In some examples, the wires of the wire mesh current collectors are pre-coated with a metal coating including a material with a melting temperature less than 500° C. In some examples, the material comprises tin (Sn), indium (In), bismuth (Bi), alloys thereof, and/or combinations thereof.

Referring now to FIG. 1, a battery cell 10 includes cathode electrodes 20-1, 20-2, . . . , and 20-C, where C is an integer greater than one. The cathode electrodes 20 include a cathode active material layer 24 arranged on one or both sides of cathode current collectors 26. The battery cell 10 includes anode electrodes 40-1, 40-2, . . . , and 40-A, where A is an integer greater than one. The anode electrodes 40 include an anode active material layer 42 arranged on one or both sides of anode current collectors 46. The cathode electrodes 20, the anode electrodes 40 and the separators 32 are arranged in a predetermined order in an enclosure 50. For example, separators 32 are arranged between the cathode electrodes 20 and the anode electrodes 40. The anode current collector 46 and/or the cathode current collector 26 comprise wire mesh that has been strengthened and/or stiffened as described below.

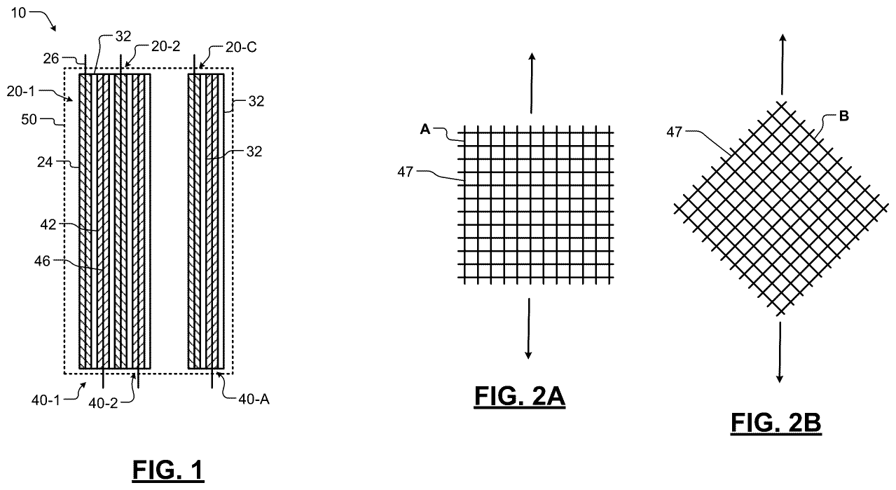

Referring now to FIGS. 2A to 4, the anode and/or cathode current collectors can include wire mesh. In FIGS. 2A and 2B, tensile testing of a wire mesh current collector 47 in two directions before strengthening and/or stiffening is shown. In FIG. 2A, the load is at 0° or 90° relative to wires of the wire mesh current collector 47. In FIG. 2B, the load is at 45° relative to wires of the wire mesh current collector 47.

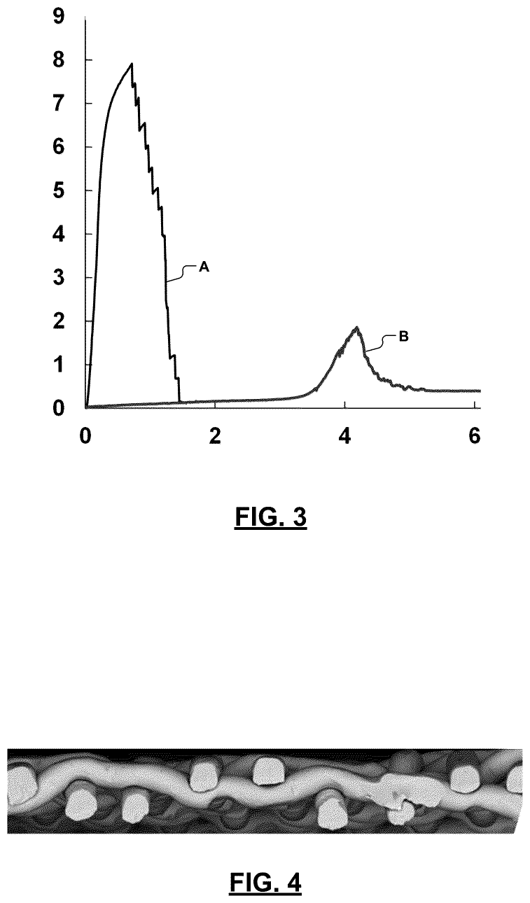

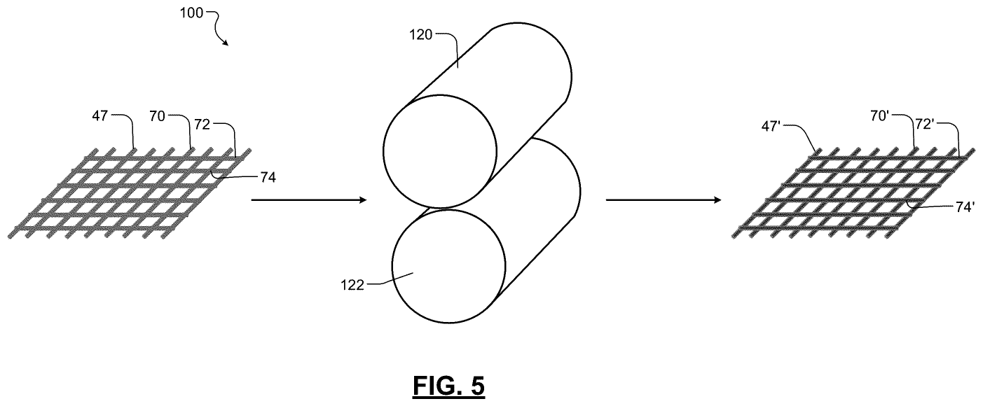

Referring now to FIG. 3, a graph illustrates load as a function of displacement in two directions for the wire mesh current collector of FIGS. 2A and 2B. Wire mesh exhibits anisotropy in its mechanical properties. When pulled in the direction in FIG. 2A, the stiffness is about 22 N/mm with peak load of about 8 N. When pulled in the direction in FIG. 2B, the stiffness is extremely low ˜0.06 N/mm with peak load at around 1.5 to 2 N. In FIG. 4, a photo shows a cutaway wire mesh current collector before strengthening and/or stiffening. Mesh junctions are weak, and the wires can easily slide over one another at these junctions, resulting in low stiffness in the 45° direction.

Referring now to FIG. 5, a method 100 for strengthening and/or stiffening of the wire mesh current collector 47 using skin pass rolling is shown. The wire mesh current collector 47 is shown to include wires 70, 72 forming mesh junctions 74. The wires 70 cross the wires 72 at 90°. In some examples, the wire mesh current collectors have a thickness in a range from 4μm to 100 μm, although other thicknesses can be used.

The wire mesh current collector 47 is passed through a first predetermined gap defined between outer surfaces of rollers 120 and 122. In some examples, the predetermined gap is selected to press the mesh junctions 74 and not the individual wires 70, 72. In some examples, the first predetermined gap is in a range from greater than or equal to the diameter of the wires and less a total thickness of the wire mesh (e.g., less than 2 times the diameter of the wires 70, 72. In some examples, the first predetermined gap is in a range from greater than or equal to greater than or equal to the diameter of the wires and less than or equal to 1.5 times the diameter of the wires 70, 72. After passing through the rollers, the wires 70′, 72′ at the mesh junctions 74′ of the wire mesh current collector 47′ are mechanically connected due to strong mechanical contact at the mesh junctions 74′.

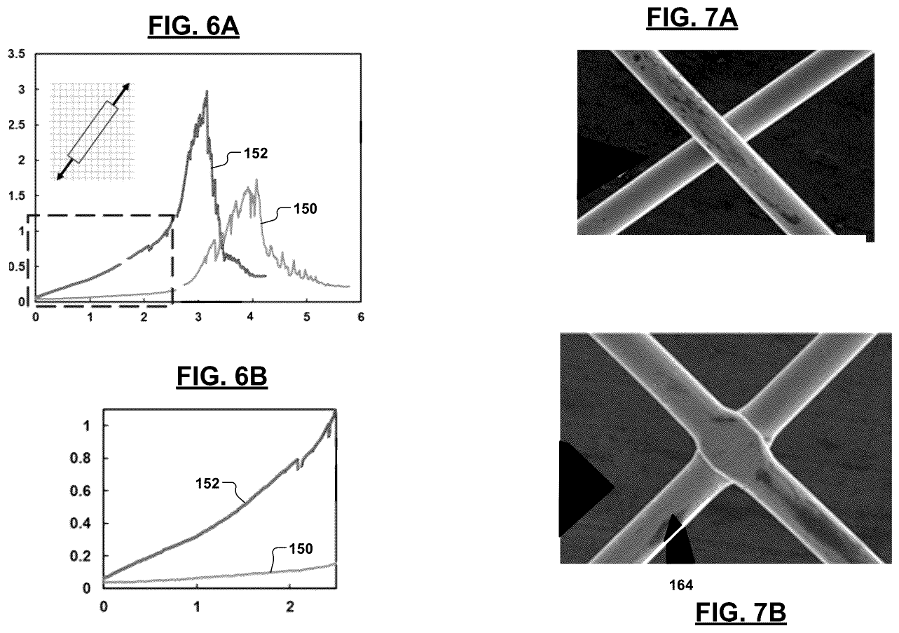

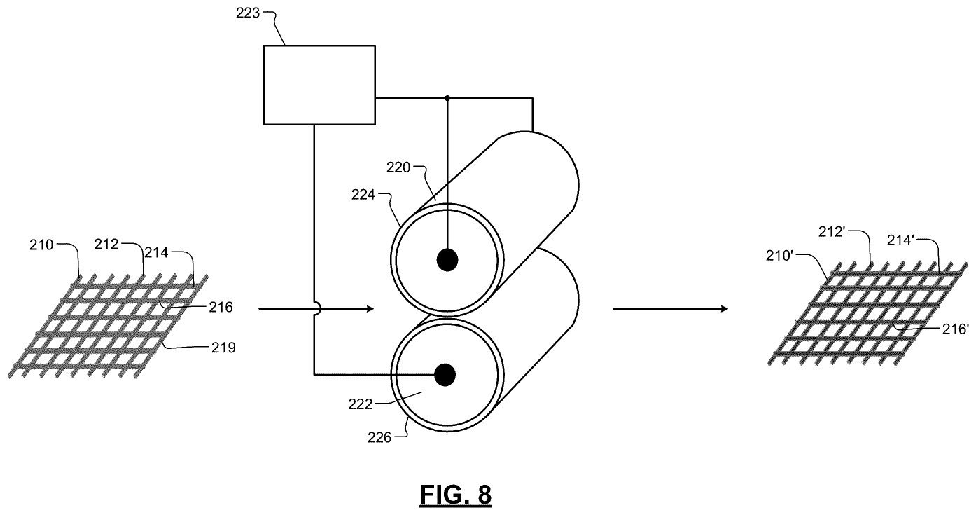

Referring now to FIGS. 6A to 7B, graphs and photos illustrate load as a function of displacement for the wire mesh current collector before (at 150 in FIGS. 6A and 6B) and after skin pass rolling (at 152 in FIGS. 6A and 6B). The strengthening and/or stiffening performance of the wire mesh current collector increases after strengthening and/or stiffening. The wire mesh current collector 47′ is approximately two times stronger as shown in FIG. 6A and approximately seven times stiffer than the wire mesh current collector 47 as shown in FIG. 6B.

In FIGS. 7A and 7B, photos of examples of wires at a mesh junction before and after strengthening and/or stiffening of the wire mesh current collector are shown. Before rolling, the wires 70, 72 pass over one another as shown in FIG. 7A. In some examples, the wires 70′, 72′ are pressed together after rolling and mechanically connected at the mesh junctions 74′ without changing the dimensions of the wires 70′, 72′.

Referring now to FIG. 8, a method for strengthening and/or stiffening of the wire mesh current collector using roll resistance welding is shown. The wire mesh current collector 210 is shown to include wires 212, 214 forming mesh junctions 216. The wires 212 cross the wires 214 at around 90°. In some examples, the wire mesh current collectors have a thickness in a range from 4 μm to 100 μm, although other thicknesses can be used. The wire mesh current collector 210 is passed through rollers 220 and 222 defining a second predetermined gap. A power source 223 supplies current such as DC or AC current across the rollers 220 and 222. In some examples, the feed rate is in a range from 5 to 30 m/min. In some examples the current is in a range from 2 to 4 kA, and pressure is in a range from 3 to 20 kg/cm².

In some examples, the second predetermined gap is set to contact and/or press the mesh junctions 216 and not the individual wires 212, 214. As the wire mesh current collector passes through the rollers 220 and 222, the rollers 220 and 222 makes contact and pass current from the power source through the wire mesh current collector to resistively heat the wire mesh current collector 210 and fuse, bond, and/or weld the mesh junctions 216 together. In some examples, the second predetermined gap is in a range from 1.5 to 2 times the diameter of the wires 212, 21. After passing through the rollers 220 and 222, the wires 70′, 72′ at the mesh junctions 74′ of the wire mesh current collector 47′ are fused, bonded and/or welded together.

In some examples, the wire mesh current collector 210 is pre-coated with a coating layer 219 to enhance soldering of the mesh junctions 216 during roll welding. In some examples, the coating layer 219 includes metal having a melting temperature less than 500° C. The current passed through the mesh will melt the coating instead of the wires and allow the wires to fuse together due to sintering of the coating layer. In some examples, the coating layer 219 includes one or more materials selected from a group consisting of tin (Sn), indium (In), bismuth (Bi), zinc (Zn), alloys thereof, and combinations thereof.

In some examples, the rollers 220 and 222 include outer layers 224 and 226, respectively, that include a refractory metal alloy. In some examples, the refractory metal alloy comprises a material selected from a group consisting of an alloy of copper (Cu) and tungsten (W) (e.g., Tuffaloy (Cu—W)), pure W, or pure molybdenum for non-ferrous meshes (Cu, brass, bronze) with high electrical conductivity.

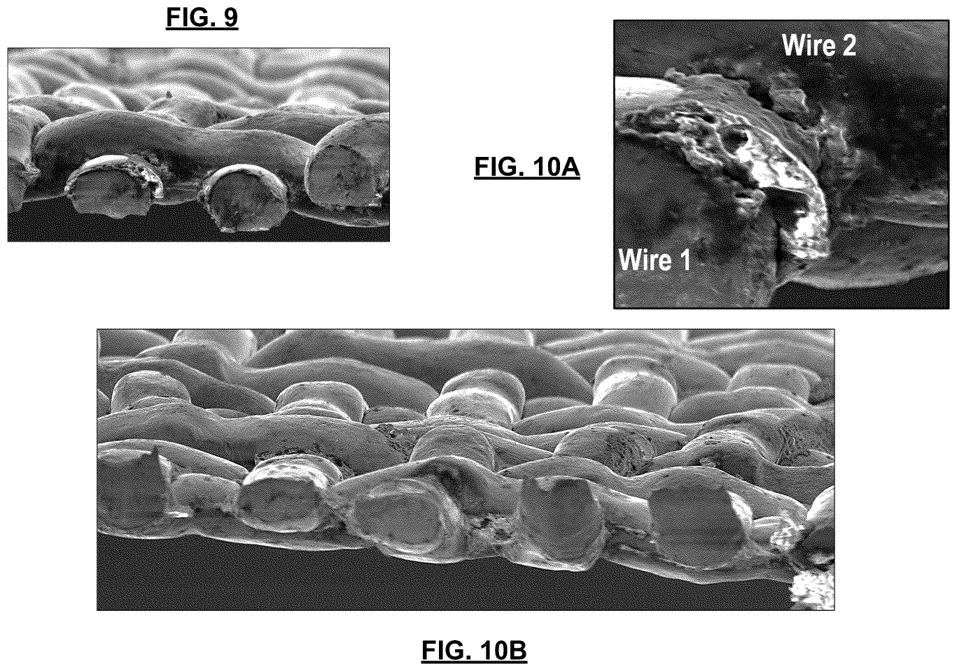

Referring now to FIGS. 9 to 10B, photos of wires at a mesh junction after strengthening and/or stiffening of the wire mesh current collector using the method in FIG. 8.

The method for strengthening and/or stiffening wire mesh current collectors is simple and inexpensive. The strengthened and/or stiffened wire mesh current collectors enable wider electrodes. The wire mesh current collectors may also have reduced resistance due to the improved contact between the wires at the mesh junctions. Reduced resistance reduces heating of the battery cell and improves battery cell and/or electrode efficiency by reducing losses due to resistance.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing a current collector for an electrode of a battery cell, comprising:
providing a wire mesh current collector including wires that have a diameter and form mesh junctions; and
rolling the wire mesh current collector using a first roller and a second roller, wherein the first roller and the second roller are spaced by a predetermined gap,
wherein the predetermined gap is less than 2 times the diameter of the wires of the wire mesh current collector.

2. The method of claim 1, wherein the predetermined gap is in a range from greater than or equal to 1 times the diameter of the wires of the wire mesh current collector.

3. The method of claim 1, wherein the diameter of the wires is in a range from 4 μm to 100 μm.

4. The method of claim 1, wherein the wires of the wire mesh current collector are made of one or more materials selected from a group consisting of copper, stainless steel, brass, bronze, zinc, and aluminum.

5. The method of claim 1, wherein the predetermined gap is in a range from greater than or equal to 1 and less than or equal to 1.5 times the diameter of the wires of the wire mesh current collector.

6. The method of claim 1, further comprising arranging an anode active material layer adjacent to the wire mesh current collector.

7. The method of claim 1, further comprising arranging a cathode active material layer adjacent to the wire mesh current collector.

8. The method of claim 1, further comprising coating the wire mesh current collector with a slurry including anode active material.

9. The method of claim 1, further comprising coating the wire mesh current collector with a slurry including cathode active material.

10. A method for manufacturing a current collector for an electrode of a battery cell, comprising:
providing a wire mesh current collector including wires that have a diameter and form mesh junctions;
rolling the wire mesh current collector using a first roller and a second roller, wherein the first roller and the second roller are spaced by a predetermined gap; and
supplying current to the first roller and the second roller to heat the wire mesh current collector to at least one of fuse, bond and weld the wires at the mesh junctions,
wherein the predetermined gap is less than 2 times the diameter of the wires of the wire mesh current collector.

11. The method of claim 10, wherein:
the predetermined gap is greater than or equal to the diameter of the wires of the wire mesh current collector.

12. The method of claim 10, wherein the diameter of the wires is in a range from 4 μm to 100 μm.

13. The method of claim 10, wherein the wires of the wire mesh current collector are made of one or more materials selected from a group consisting of copper, stainless steel, brass, bronze, and aluminum.

14. The method of claim 10, wherein the predetermined gap is in a range from greater than or equal to 1.5 and less than or equal to 2 times the diameter of the wires of the wire mesh current collector.

15. The method of claim 10, further comprising arranging an anode active material layer adjacent to the wire mesh current collector.

16. The method of claim 10, further comprising arranging a cathode active material layer adjacent to the wire mesh current collector.

17. The method of claim 10, further comprising coating the wire mesh current collector with a slurry including anode active material.

18. The method of claim 10, further comprising coating the wire mesh current collector with a slurry including cathode active material.

19. The method of claim 10, wherein:
the first roller and the second roller include a radially outer layer comprising a refractory metal, and
the refractory metal is selected from a group consisting of tungsten, molybdenum, and an alloy of copper and tungsten.

20. The method of claim 10, further comprising coating the wire mesh current collector prior to rolling using one or more materials selected from a group consisting of tin (Sn), indium (In), bismuth (Bi), zinc (Zn), and combinations thereof.
